(19) United States
(12) Patent Application Publication
(10) Pub. No.: US 2022/0250210 A1
(43) Pub. Date: Aug. 11, 2022

(54) METHOD FOR PRODUCING ABRASIVE PARTICLES

(71) Applicant: Tyrolit - Schleifmittelwerke Swarovski K.G., Schwaz (AT)

(72) Inventor: Martin HIRSCHMANN, Wattenberg (AT)

(21) Appl. No.: 17/731,572

(22) Filed: Apr. 28, 2022

Related U.S. Application Data
(63) Continuation of application No. PCT/AT2020/060368, filed on Oct. 13, 2020.

(30) Foreign Application Priority Data
Oct. 30, 2019 (AT) A 50934/2019

(51) Int. Cl. B24D 18/00; C09K 3/14; C01F 7/444

(52) U.S. Cl. CPC B24D 18/0063; C09K 3/1418; C01P 2004/30; C01P 2004/60; C01F 7/444

(57) ABSTRACT

A method for producing abrasive particles includes: i) providing a starting mixture which contains at least aluminum hydroxide and which can be converted at least into aluminum oxide by a heat treatment, ii) extruding the starting mixture in order to form an extrudate, iii) separating the extrudate into intermediate particles, and iv) heat-treating the intermediate particles. The intermediate particles are converted into abrasive particles which contain aluminum oxide, and the starting mixture is pressed through at least one nozzle element with a plurality of substantially parallel nozzle channels. The nozzle channels are preferably arranged in a mutually spaced manner over the course of the extrusion process, and the extrudate has a spiral or hollow cylindrical shape at least in some sections.

### BACKGROUND OF THE INVENTION

The invention concerns a method of producing abrasive particles and abrasive particles produced in accordance with the method. The invention further concerns a method of producing a grinding tool for machining metallic materials and the grinding tool produced in accordance with that method and a nozzle body used in the method according to the invention.

Different methods of producing abrasive particles are known from the state of the art. For example, EP 3 342 839 A1 to the present applicant discloses a method in which abrasive particles of a non-uniform shape and/or size are produced by cutting an extrudate. In that respect, the aim with that method is to produce abrasive particles with an irregular geometry.

A disadvantage there is that only comparatively few abrasive particles can be produced in a given time.

Furthermore, such a method involves a relatively high level of wear as the cutting edges used for the cutting operation are subject to a high loading and thus wear comparatively quickly.

### SUMMARY OF THE INVENTION

The object of the present invention is to provide a method of producing abrasive particles, which avoids the above-mentioned problems, the abrasive particles produced therewith, a method of producing a grinding tool for machining metallic materials, in which the abrasive particles produced according to the invention are used, a grinding tool produced by means of that method, and a nozzle body used in the method according to the invention.

It is therefore provided in a method according to the invention in the course of the extrusion operation the starting mixture is pressed through at least one nozzle body having a plurality of nozzle passages which extend substantially parallel, preferably wherein the at least one nozzle body was produced by an additive production method and/or at least a material-removing production method.

The plurality of nozzle passages in the nozzle body provide that more abrasive particles can be produced in the same time, than with methods known from the state of the art. In addition, the wear with the method according to the invention is less than in the state of the art as no cutting apparatus is required.

It is to be pointed out that the technology of converting a starting mixture containing at least aluminum hydroxide at least into aluminum oxide by heat treatment has already long been known. In this connection attention is directed to the so-called “sol-gel process”. That involves using a starting mixture containing at least aluminum hydroxide. Aluminum hydroxide can occur in different modifications. In connection with the present invention boehmite in powder form (γ-AlOOH) is preferably used. Further preferably the boehmite is subsequently converted into a clear sol with the addition of water and the addition of a peptizator, for example nitric acid. Preferably then a reaction to provide the gel, that is to say dehydration and polymerization, is initiated by the further addition of an acid, for example nitric acid, or a nitrate solution. The gelling step results in the boehmite being in a very homogenously distributed form. Liberated water can be evaporated in a subsequent working step. In the course of a subsequent heat treatment at a temperature between 400° C. and 1200° C., preferably at a temperature between 800° C. and 1000° C., the aluminum hydroxide can be converted into an aluminum oxide of the transitional phase γ-Al₂O₃. In the reaction of boehmite to aluminum oxide nitrogen is liberated as a residue of the acid and water. That low-temperature firing operation is also referred to as calcination. Then in a last step a further heat treatment can be carried out in the form of a preferably pressure-less sintering. That step is preferably effected at a temperature of between 1200° C. and 1800° C., preferably at a temperature of between 1200° C. and 1500° C. Depending on the starting mixture, besides aluminum oxide (typically as alpha-aluminum oxide), secondary phases such as spinel can occur. Account is taken of that situation by the expression “at least into aluminum oxide”.

The term “extrusion” is used to denote a procedure in which solid to viscous hardenable materials are continuously pressed under pressure out of a shaping opening. That results in bodies with the cross-section of the opening, referred to as the extrudate.

The term “material-removing production method” is used to denote for example production methods like boring and milling or also laser or water jet cutting.

In the present case, the cross-section of the extrudate depends on the nozzle body used and is preferably rectangular, square, triangular or star-shaped and/or has at least one convex side or at least one concave side.

The method according to the invention for the production of abrasive particles is distinguished over the state of the art not only by its simplicity and the lower maintenance requirement and wear, but it also makes it possible to vary the shape and/or size of the intermediate particles or the abrasive particles occurring after the sintering operation easily and flexibly by changing the nozzle body and/or upon changes in the separation operation.

A possible way of influencing or controlling the dimensions of the abrasive particles provides feeding the extrudate to the separation method step at a variable delivery speed and/or in an oscillating movement. In the case of an oscillating movement that involves a given length of the extrudate to be separated.

It can further also be provided that the intermediate particles produced by the separation operation are comminuted prior to the heat treatment in a further method step, preferably by a cutting apparatus. Instead of a cutting apparatus, it is also possible to use other comminuting apparatuses which for example also cause the intermediate particles to be broken up and/or chopped.

A further possible way of influencing the shape and/or size of the abrasive particles involves changing the consistency of the starting mixture. For that purpose, in the preparation of the starting mixture and/or in the extrusion of the starting mixture water, a peptizator, preferably nitric acid, and/or additives, for example an acid which can also be nitric acid, and/or nitrate, preferably cobalt nitrate, are added.

Advantageous embodiments of the method of producing abrasive particles further provide that the intermediate particles created by the separation operation, in the course of the heat treatment, are calcined, preferably at a temperature of between 400° C. and 1200° C., particularly preferably at a temperature of between 800° C. and 1000° C., and/or are sintered, preferably at a temperature of between 1200° C. and 1800° C., particularly preferably at a temperature of between 1200° C. and 1500° C. In addition it can be provided that the intermediate particles created by the separation operation are pre-dried in the course of the heat treatment prior to calcining and/or sintering, preferably at a temperature beween 50° C. and 350° C., particularly preferably at a temperature beween 80° C. and 100° C.

As previously stated, protection is also claimed for a method of producing a grinding tool for machining metallic materials, wherein abrasive particles which were produced according to the method according to the invention of producing abrasive particles are incorporated into a binding, for example a ceramic binding or a synthetic resin binding. Advantageously that affords a grinding tool of a porosity of 2 to 50% and/or a density of 1.5 to 4.5 g/cm³.

Protection is also claimed for a nozzle body used in the method according to the invention. It is provided that the nozzle passages of the at least one nozzle body respectively have a preferably circular or ellipsoidal inlet opening through which the starting mixture passes into the nozzle passages and a respective outlet opening which is preferably rectangular, square, triangular or star-shaped and/or has at least one convex side or at least one concave side and for issue of the extrudate from the nozzle passages. The outlet opening however can basically be of any suitable shape.

Particularly preferably, a part of the nozzle passages, preferably all nozzle passages, have a portion which adjoins the outlet opening and which is in the form of a twisted prism for conversion of the starting mixture to be extruded into a spiral shape.

With such a configuration of the nozzle body, it is possible to easily produce spiral-shaped abrasive particles of the most widely varying cross-section. The abrasive particles can be adapted to various use conditions by virtue of the variable cross-section.

The result of the spiral configuration of the abrasive particles is that, on the one hand, incorporation of the abrasive particles into a binding - for example in the production of a grinding tool according to the invention - is facilitated. On the other hand, in the course of use of the grinding tool or the abrasive particles, fresh cutting edges of differing configuration, facing in different directions in space, are repeatedly offered, and they permit particularly efficient removal of material.

### BRIEF DESCRIPTION OF THE DRAWINGS

Further details and advantages of the present invention are described more fully hereinafter by the specific description with reference to the drawings in which:

FIG. 1 shows a preferred embodiment of the method according to the invention of producing abrasive particles,

FIG. 2a is a sectional view of an embodiment of a nozzle body,

FIG. 2b shows a negative of a nozzle passage of a nozzle body as shown in FIG. 2a,

FIG. 3a is a sectional view of a further embodiment of a nozzle body,

FIG. 3b shows a negative of a nozzle passage of a nozzle body as shown in FIG. 3a,

FIG. 3c is a further sectional view of an embodiment of a nozzle body as shown in FIG. 3a,

FIG. 4a is a sectional view of a further embodiment of a nozzle body,

FIG. 4b shows a negative of a nozzle passage of a nozzle body as shown in FIG. 4a,

FIGS. 5a/5b are photographs of abrasive particles which were produced according to a preferred embodiment of the method according to the invention of producing abrasive particles with a configuration of a nozzle body as shown in one of FIGS. 2a, 3a and 4a,

FIG. 6a is a sectional view of a further embodiment of a nozzle body,

FIG. 6b is a diagrammatic view of an interference body according to the invention,

FIG. 7a is a diagrammatic view of an abrasive particle which was produced according to a preferred embodiment of the method according to the invention of producing abrasive particles with an embodiment of a nozzle body as shown in

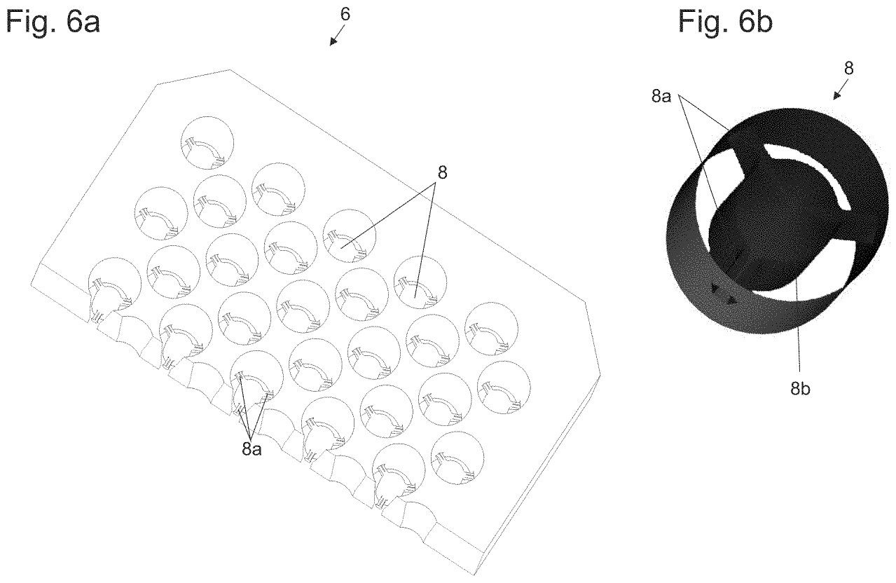

FIG. 6a as a perspective front view,

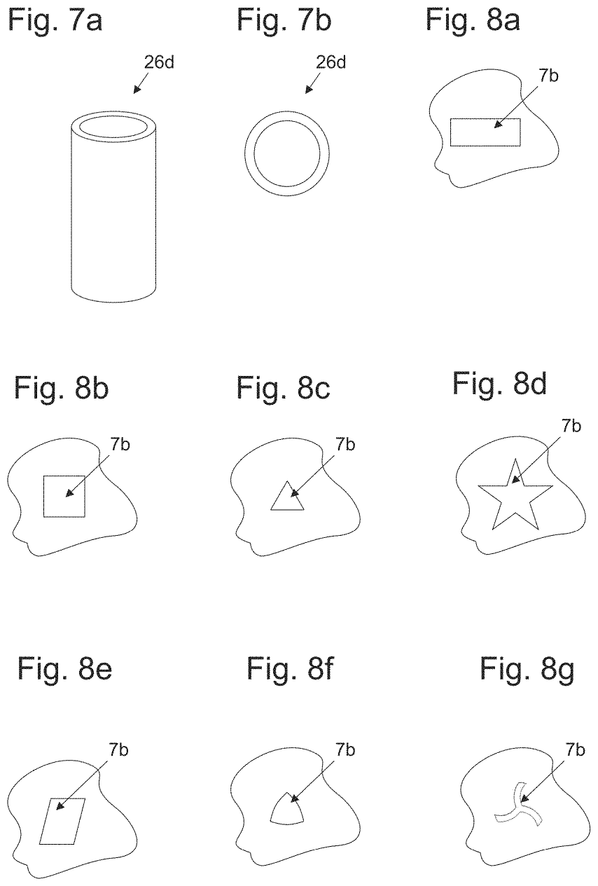

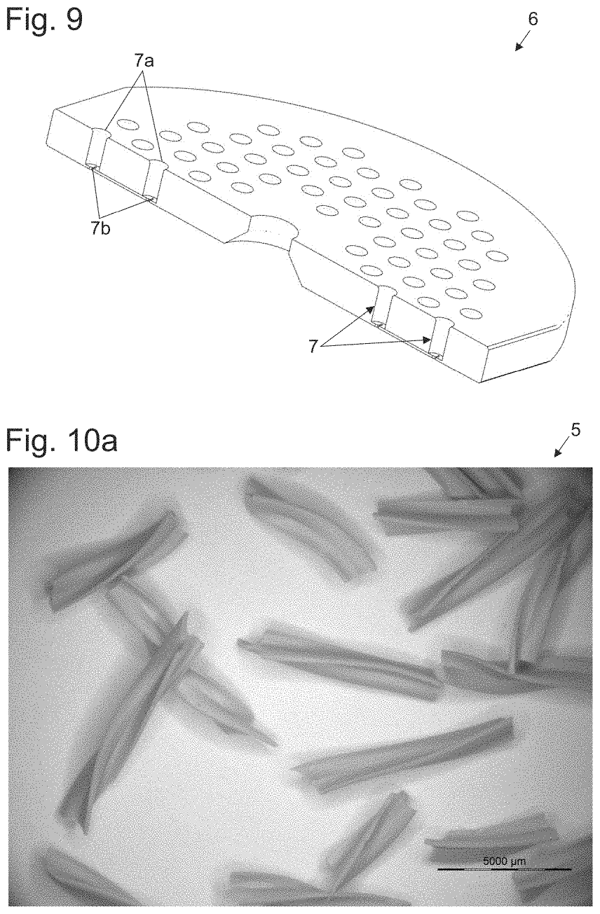

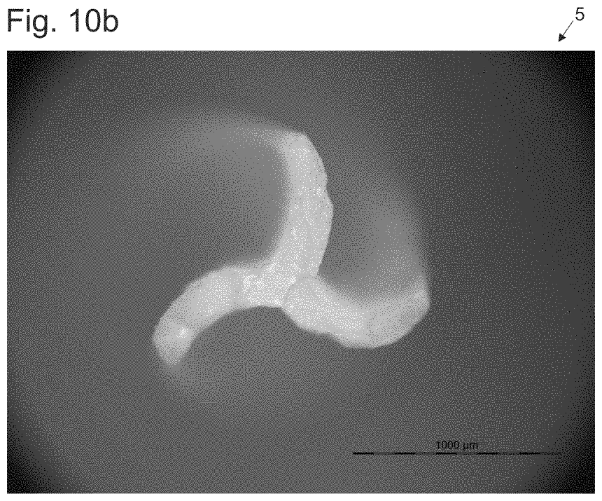

FIG. 7b is a diagrammatic view of an abrasive particle which was produced according to a preferred embodiment of the method according to the invention of producing abrasive particles with an embodiment of a nozzle body as shown in FIG. 6a as a plan view,

FIGS. 8a-g are diagrammatic views of outlet openings of nozzle passages of a nozzle body according to the invention,

FIG. 9 is a sectional view of a further embodiment of a nozzle body,

FIG. 10a is a photograph of abrasive particles which were produced according to an embodiment of the method according to the invention of producing abrasive particles with an embodiment of a nozzle body as shown in FIG. 9, and

FIG. 10b is a photograph of an abrasive particle as a front view, which was produced according to an embodiment of the method according to the invnention of producing abrasive particles with an embodiment of a nozzle body as shown in FIG. 9.

### DETAILED DESCRIPTION OF THE INVENTION

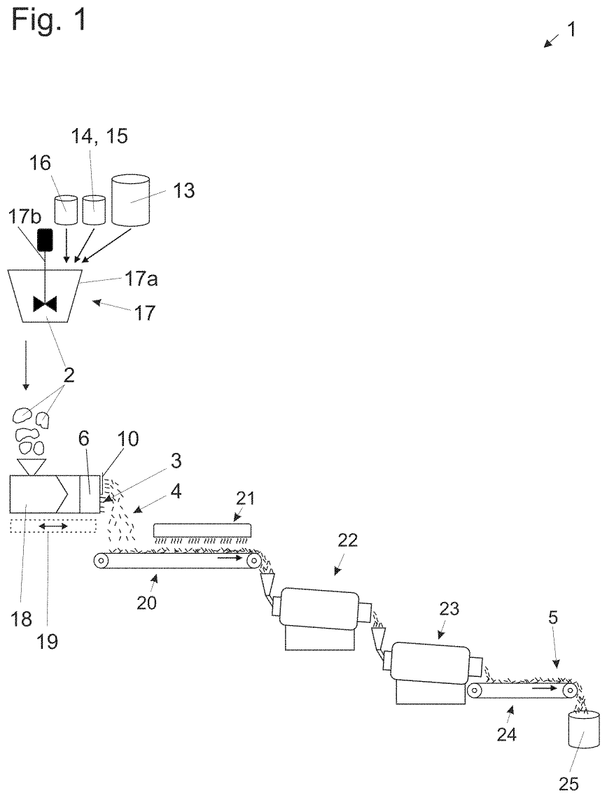

In the preferred embodiment shown in FIG. 1 of the method 1 according to the invention of producing abrasive particles a starting mixture 2 is prepared by boehmite 13, water 14, nitric acid 15 and additives 16, for example cobalt nitrate, being introduced into a mixer 17, wherein the mixer 17 substantially comprises a mixing container 17a and a rotational unit 17b arranged therein.

The starting mixture 2 produced in that way is subsequently fed to an extrusion apparatus 18. It can provided that the extrusion apparatus 18 is arranged on a platform 19 which can be displaced in an oscillating movement. That oscillating movement is diagrammatically indicated by means of a double-headed arrow in FIG. 1.

The extrudate 3 leaving the extrusion apparatus 8 is of a given cross-sectional shape which is determined by the nozzle body.

The extrudate 3 is subsequently separated by a rotating or oscillating blade 10. It can also be provided that separation into intermediate particles is effected by means of at least one laser or at least one water cutter or at least one plasma cutter, preferably wherein the extrudate 3 which is to be separated by means of the at least one laser or the at least one water cutter or the at least one plasma cutter is deposited on a conveyor means prior to the separation operation.

The intermediate particles 4 created by separation of the extrudate 3 are fed to a pre-drying device 21 by means of a belt guide 20. It can also be provided that it is only after being deposited on the belt guide 20 that the extrudate 3 is separated on the belt guide 20.

Then the pre-dried intermediate particles 4 are transferred into a calcination furnace 22 in which calcination of the intermediate particles 4 takes place.

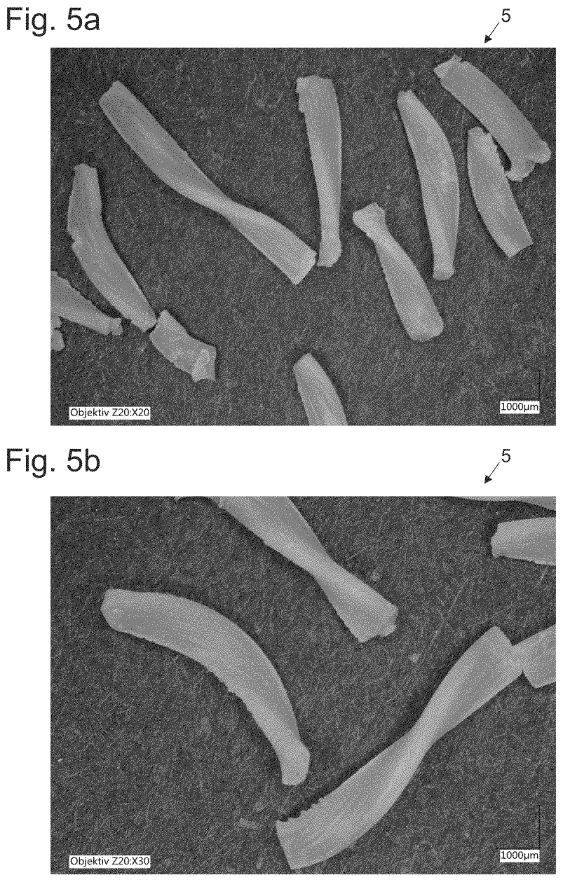

Following the calcination operation there is a sintering furnace 23 in which the intermediate particles 4 are sintered to give abrasive particles 5. The shape and the size of the abrasive particles 5 produced in that way is discussed in greater detail with reference to FIGS. 5a and 5b.

Instead of three devices 21, 22 and 23 for the heat treatment, which follow each other in spatially separated relationship, it is also possible to use an integrated device for the heat treatment, for example a tunnel furnace, with temperature zones which are controllable independently of each other.

The sintered abrasive particles 5 are positioned on a belt guide 24. During transport by means of that belt guide device 24 the abrasive particles 5 created by the sintering operation are cooled down.

The finished abrasive particles 5 are then transferred into a storage device 25 and are available for further processing, for example for a method of producing a grinding tool for machining metallic materials.

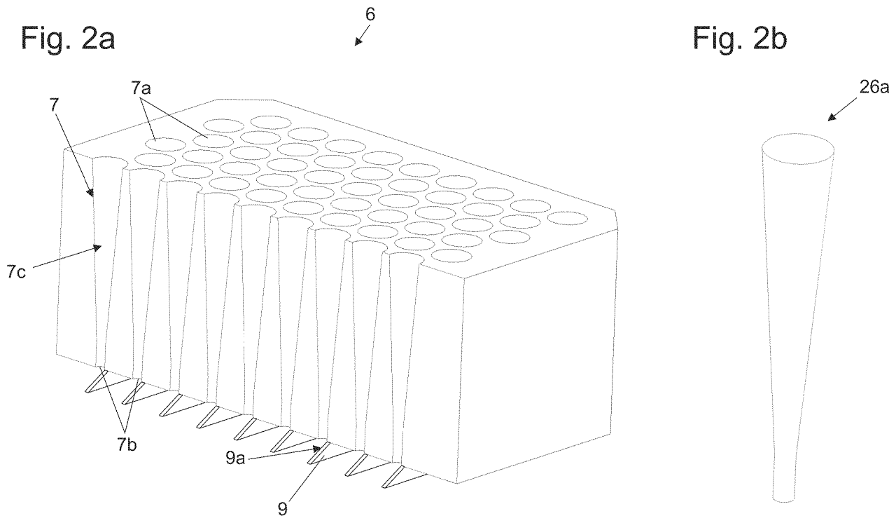

FIG. 2a shows a sectional view of an embodiment of a nozzle body 6 according to the invention. It can be seen that the nozzle body 6 has a plurality of nozzle passages 7. The nozzle passages 7 together respectively comprise an inlet opening 7a, a funnel-shaped portion 7c adjoining same and an outlet opening 7b. In this embodiment the nozzle body 6 further has a baffle body 9 having a baffle surface 9a. The baffle body 9 and/or the baffle surface 9a can also be of a shovel-shaped configuration.

In the case of a nozzle body 6 as shown in FIG. 2 a starting mixture 2 to be extruded therefore passes into the nozzle body 6 through the inlet openings 7a and by virtue of the funnel-shaped portion 7c experiences an increase in its density and/or its speed. The mixture 2 to be extruded then issues from the nozzle body 6 in the form of an extrudate 3 through the outlet openings 7b and is deflected by the baffle surfaces 9a of the baffle bodies 9. After deflection the extrudate 3 is separated into individual intermediate particles 4.

For the sake of better understanding FIG. 2b shows a negative 26a of a nozzle passage 7 of a nozzle body 6 as shown in FIG. 2a.

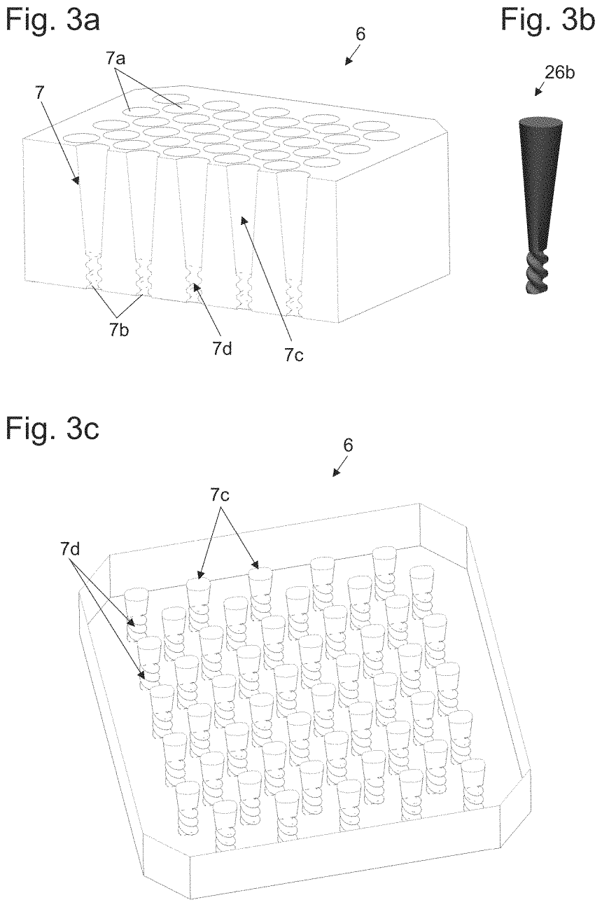

FIG. 3a shows a sectional view of a further embodiment of a nozzle body 6 according to the invention. This nozzle body 6 also has a plurality of nozzle passages 7 each having an inlet opening 7a, an outlet opening 7b and a funnel-shaped portion 7c. In this embodiment a twisted portion 7d is arranged between the outlet opening 7b and the funnel-shaped portion 7c.

After passing through the twisted portion 7d the extrudate 3 issues in a spiral shape from the outlet openings 7b and can then be separated.

FIGS. 3b and 3c show a negative 26b of a nozzle passage 7 and a further sectional view of a nozzle body 6 as shown in FIG. 3a. It can be seen from this Figure that the funnel-shaped portion 7c also changes its cross-section with its diameter. In this embodiment the cross-section changes from a circular cross-section to a rectangular cross-section. The twisted portion 7d therefore is substantially in the form of a twisted prism with a rectangular base surface.

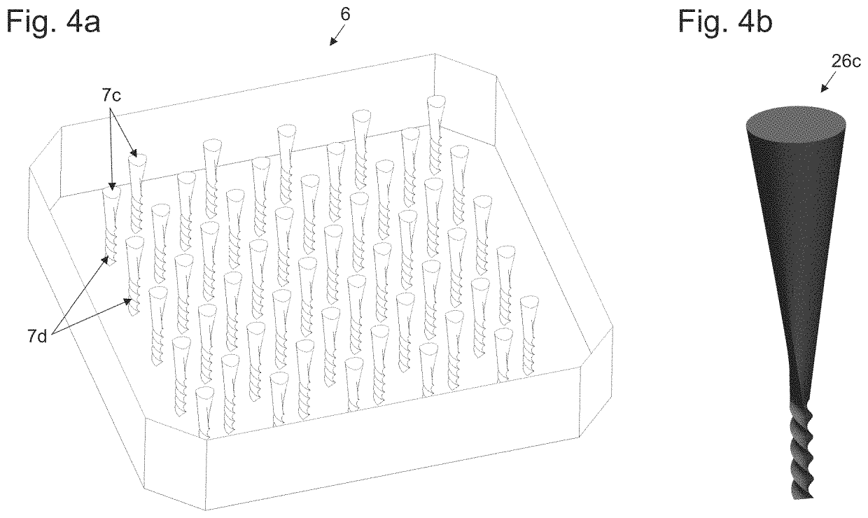

FIG. 4a shows a sectional view of a further embodiment of a nozzle body 6 according to the invention. This embodiment differs from that shown in FIGS. 3a through 3c in that a cross-section of the nozzle passage 7 changes not to a rectangular cross-section but to a triangular cross-section. The twisted portion 7d in this embodiment is therefore substantially in the form of a twisted prism with a triangular base surface.

For better understanding FIG. 4b shows a negative 26c of a nozzle passage 7 of a nozzle body 6 as shown in FIG. 4a.

FIGS. 5a and 5b show photographs of abrasive particles which were produced in accordance with a method according to the invention of producing abrasive particles 5 with an embodiment of a nozzle body as shown in one of FIG. 2a, 3a or 4a. By reference to the photographs it is possible to see on the one hand the size of the abrasive particles 5 and on the other hand the shape of the abrasive particles 5. It can be seen that a large part of the abrasive particles 5 from the sample photographed involve a twist angle of 90° to 180°. In particular however it can be provided that the abrasive particles 5 have a twist angle of up to 360°.

FIG. 6a shows a sectional view of a further embodiment of a nozzle body 6 according to the invention. It can be seen that a respective interference body 8 is arranged in the nozzle passages 7, the body 8 being arranged at the inside walls of the respective nozzle passage 7 by means of three bars 8a. Basically however any number of bars 8a can be provided. The interference body 8 has a torpedo-shaped tip 8b in the direction of the inlet openings 7a, as can be seen from FIG. 6b.

In this embodiment the starting material 2 to be extruded is shaped by the interference bodies 8 in the nozzle passages 7 to give an extrudate 3 in the shape of a hollow body. Separation of the extrudate 3 into individual intermediate particles 4 is then in turn effected. Those intermediate particles are diagrammatically shown in FIGS. 7a and 7b.

A configuration of the intermediate particles 4, in the form of hollow bodies, is advantageous in particular when producing a grinding tool 12 according to the invention as a binding can also penetrate into the hollow space in the abrasive particles 5, whereby improved anchorage of the abrasive particles 5 on the grinding tool 12 is achieved in comparison with abrasive particles 5 in the form of solid bodies.

It is also conceivable for an interference body 8 according to the invention to be arranged in relation to nozzle bodies 6 with twisted portions 7d. That affords twisted intermediate particles 4 and abrasive particles 5 in the form of hollow bodies.

FIGS. 8a through 8g show diagrammatic views of outlet openings 7b of nozzle passages 7 of a nozzle body 6 according to the invention. It can be seen that the outlet openings 7b can be of the most widely varying geometrical shapes. The outlet openings 7b shown in FIGS. 8a through 8g are only intended to serve as examples, in principle any suitable geometrical shapes are conceivable for the outlet openings 7b.

FIG. 9 shows a sectional view of a further embodiment of a nozzle body 6. It can be seen that this embodiment does not have a funnel-shaped portion 7c and also no twisted portion 7d. The nozzle passage 7 is therefore of a substantially cylindrical configuration and is of the same diameter as the inlet opening 7a.

In a nozzle body 6 as shown in FIG. 9 a starting mixture 2 to be extruded therefore passes into the nozzle body 6 through the inlet openings 7a and by virtue of the outlet openings 7b experiences an increase in its density and/or its speed.

The mixture 2 to be extruded then issues from the nozzle body 6 in the form of an extrudate 3 through the outlet openings 7b. The outlet openings 7b in this embodiment are similar in their shape to a three-blade rotor.

The nozzle body 6 shown in FIG. 9 can be produced by an additive production method or by at least one material-removing production method.

In the case of a material-removing production it could be provided for example that blind hole bores are produced in a metal blank. Outlet openings 7b are then cut out in those blind hole bores by means of laser cutting. It is however also possible to involve any other suitable production method.

FIG. 10a shows a photograph of abrasive particles which were produced according to a method according to the invention of producing abrasive particles 5 with an embodiment of a nozzle body as shown in FIG. 9. On the one hand the size of the abrasive particles 5 and on the other hand the shape of the abrasive particles 5 can be seen from the photograph.

It can be seen that a large part of the abrasive particles 5 from the photographed sample involve a twist angle of 90° to 180°. In particular however it can be provided that the abrasive particles 5 have a twist angle of up to 360°.

FIG. 10b shows a photograph of an abrasive particle in a front view, which was produced according to a method according to the invention of producing abrasive particles 5 with an embodiment of a nozzle body as shown in FIG. 9. The size of an abrasive particle and its cross-section can be seen from the photograph.

### LIST OF REFERENCES

1 method
2 starting mixture
3 extrudate
4 intermediate particles
5 abrasive particles
6 nozzle body
7 nozzle passages

7a inlet opening

7b outlet opening

7c funnel-shaped portion

7d twisted portion
8 interference body

8a bar

8b torpedo-shaped tip
9 baffle body

9a baffle surface
10 blade
11 conveyor means
12 grinding tool
13 boehmite
14 water
15 nitric acid
16 additives
17 mixer

17a mixing container

17b rotational unit
18 extrusion device
19 platform
20 belt guide
21 pre-drying unit
22 calcination furnace
23 sinering furnace
24 belt guide device
25 storage device

1. A method of producing abrasive particles having the following method steps:
i. providing a starting mixture which contains at least aluminum hydroxide and which can be converted at least into aluminum oxide by heat treatment,
ii. extrusion of the starting mixture to form an extrudate,
iii. separating the extrudate into intermediate particles, and
iv. heat treatment of the intermediate particles, wherein the intermediate particles are converted into abrasive particles which contain aluminum oxide,
wherein in the course of extrusion the starting mixture is pressed through at least one nozzle body having a plurality of nozzle passages which extend substantially parallel and which are preferably mutually spaced, wherein the extrudate is at least portion-wise of a spiral or hollow-cylindrical configuration,
wherein the nozzle passages of the at least one nozzle body respectively have a preferably circular or ellipsoidal inlet opening through which the starting mixture passes into the nozzle passages and a respective outlet opening which is preferably rectangular, square, triangular or star-shaped and/or has at least one convex side or at least one concave side and by way of which the extrudate issues from the nozzle passages,
wherein a part of the nozzle passages, preferably all nozzle passages, have a portion which adjoins the outlet opening and which is in the form of a twisted prism whereby the starting mixture is converted into a spiral shape, and/or
that a part of the nozzle passages, preferably all nozzle passages, have a portion which adjoins the outlet opening and in which at least one interference body is arranged whereby the starting mixture to be extruded is converted into a hollow geometry, preferably wherein the at least one interference body is connected to an inside wall of the nozzle passages by way of at least one bar, preferably precisely three bars, and/or wherein the at least one interference body is arranged substantially centrally in the nozzle passages and/or wherein the at least one interference body has a torpedo-shaped tip facing towards the inlet opening, and/or
that the extrudate leaving the at least one nozzle body is deflected by at least one baffle body, preferably on to a spiral path, preferably wherein the at least one baffle body is arranged directly adjacent to the at least one nozzle body and/or has at least one baffle surface arranged inclinedly relative to the at least one nozzle body and/or has at least one shovel-shaped baffle surface.

2. The method as set forth in claim 1, wherein a part of the nozzle passages, preferably all nozzle passages, have a funnel-shaped portion adjoining the inlet opening and of a diameter which decreases in the direction of the outlet opening, whereby the density and/or the speed of the starting mixture to be extruded is increased.

3. The method as set forth in claim 1, wherein the extrudate is separated into intermediate particles mechanically, preferably by a rotating or oscillating blade and/or by means of at least one laser or at least one water cutter or at least one plasma cutter, preferably wherein the extrudate which is to be separated by means of the at least one laser or the at least one water cutter or the at least one plasma cutter is deposited on a conveyor means prior to the separation operation.

4. The method as set forth in claim 1, wherein the intermediate particles created by the separation operation, in the course of the heat treatment,
are calcined, preferably at a temperature of between 400° C. and 1200° C., particularly preferably at a temperature of between 800° C. and 1000° C., and/or
are sintered, preferably at a temperature of between 1200° C. and 1800° C., particularly preferably at a temperature of between 1200° C. and 1500° C.

5. The method as set forth in claim 4, wherein the intermediate particles created by the separation operation are pre-dried in the course of the heat treatment prior to calcination and/or sintering, preferably at a temperature of between 50° C. and 350° C., particularly preferably at a temperature of between 80° C. and 100° C.

6. The method as set forth in claim 1, wherein the abrasive particles present after the heat treatment are cooled down.

7. The method as set forth in claim 1, wherein in the preparation of the starting mixture and/or in the extrusion of the starting mixture water, a peptizator, preferably nitric acid, and/or additives, for example an acid and/or a nitrate, preferably cobalt nitrate, are added.

8. Abrasive particles produced according to the method as set forth in claim 1, wherein the abrasive particles are at least portion-wise of a spiral or hollow-cylindrical configuration.

9. The abrasive particles as set forth in claim 8, wherein the abrasive particles have a base surface which is rectangular, square, triangular or star-shaped and/or has at least one convex side or at least one concave side.

10. The abrasive particles as set forth in claim 12, wherein the abrasive particles are of a length of 0.5 mm to 4 mm, preferably between 1 mm and 2 mm, and/or
that the abrasive particles are of a width of 200 μm to 800 μm, preferably between 500 μm and 700 μm, and/or
that the abrasive particles are of a thickness of 50 μm to 400 μm, preferably 150 μm to 250 μm and/or
that the abrasive particles have a twist angle between 0° and 360°, preferably between 180° and 360°.

11. A nozzle body for use in the method of producing abrasive particles as set forth in claim 1, wherein the nozzle body has a plurality of nozzle passages extending substantially parallel, preferably wherein the nozzle body is produced by an additive production method and/or at least one material-removing production method
wherein the nozzle passages of the at least one nozzle body respectively have a preferably circular or ellipsoidal inlet opening for the entry of the starting mixture into the nozzle passages and a respective outlet opening which is preferably rectangular, square, triangular or star-shaped and/or has at least one convex side or at least one concave side and for issue of the extrudate from the nozzle passages wherein a part of the nozzle passages, preferably all nozzle passages, have a portion which adjoins the outlet opening and which is in the form of a twisted prism for conversion of the starting mixture to be extruded into a spiral shape, and/or
wherein a part of the nozzle passages, preferably all nozzle passages, have a portion which adjoins the outlet opening and in which at least one interference body is arranged for conversion of the starting mixture to be extruded into a hollow geometry, preferably wherein the at least one interference body is connected to an inside wall of the nozzle passages by way of at least one bar, preferably precisely three bars, and/or wherein the at least one interference body is arranged substantially centrally in the nozzle passages and/or wherein the at least one interference body has a torpedo-shaped tip facing towards the inlet opening.

12. The nozzle body as set forth in claim 11, wherein a part of the nozzle passages, preferably all nozzle passages, has a funnel-shaped portion adjoining the inlet opening and of a diameter which decreases in the direction of the outlet opening for increasing the density and/or the speed of the starting mixture to be extruded.

13. The nozzle body as set forth in claim 11, wherein the outlet openings are of a size of 0.1 mm to 1.0 mm, preferably 0.3 mm to 0.8 mm.

14. A method of producing a grinding tool for machining metallic materials, wherein abrasive particles which were produced according to the method as set forth in claim 1 are incorporated into a binding, for example a ceramic binding or a synthetic resin binding.

15. A grinding tool produced according to a method as set forth in claim 14, wherein the grinding tool has a porosity of 2% to 50% and/or a density of 1.5 g/cm³ to 4.5 g/cm³.
